(19) United States
(12) Patent Application Publication
(10) Pub. No.: US 2025/0060005 A1
(43) Pub. Date: Feb. 20, 2025

(54) SEALING MEMBER HAVING INTERNAL PRESSURE DISCHARGING FUNCTION AND BEARING DEVICE PROVIDED THEREWITH

(71) Applicant: ILJIN GLOBAL Co.,Ltd, Seoul (KR)

(72) Inventors: Yong Won KIM, Seoul (KR); Seong Kyu JIN, Seoul (KR)

(73) Assignee: ILJIN GLOBAL Co.,Ltd, Seoul (KR)

(21) Appl. No.: 18/807,476

(22) Filed: Aug. 16, 2024

(30) Foreign Application Priority Data
Aug. 16, 2023 (KR) 10-2023-0107197

(51) Int. Cl. F16C 33/78; F16C 19/38

(52) U.S. Cl. CPC F16C 33/7816; F16C 19/385; F16C 2326/02

(57) ABSTRACT

There is provided a sealing member of a bearing device configured to rotatably support a rotary element relative to a non-rotary element in a rotating device via rolling elements. The sealing member includes a frame mounted on one of the rotary element and the non-rotary element, and an elastic sealing portion attached to the frame. The frame includes a press-fitting portion extending in an axial direction and a flange portion extending in a radial direction from the press-fitting portion. The flange portion of the frame may have a through-hole, the elastic sealing portion may be configured to close the through-hole. At least one perforated-hole may be formed in the elastic sealing portion configured to close the through-hole, and a bearing space, in which the rolling elements are located, may be in communication with an outside via the at least one perforated-hole.

### CROSS-REFERENCE TO RELATED APPLICATION

This application claims priority to Korean Patent Application No. 10-2023-0107197 filed on Aug. 16, 2023, the entire contents of which are herein incorporated by reference.

### TECHNICAL FIELD

The present invention relates to a sealing member having an internal pressure discharging function and a barring device including the same, and more particularly, to a sealing member configured to prevent high internal pressure from being generated in a bearing space using an internal pressure discharging structure formed in the sealing member, and a bearing device including the same.

### BACKGROUND

A bearing is a part for rotatably mounting and supporting a rotary element relative to a non-rotary element in a rotating device, and may be used in a part such as a shaft of a vehicle or the like, which require rotatable support.

Referring to FIG. 1, there is exemplarily illustrated, as an example of a bearing device, a vehicular wheel bearing 10 which rotatably mounts and supports a vehicular wheel to a vehicle body.

As illustrated in FIG. 1, in the vehicular wheel bearing 10, a rotary element 20 on which the vehicular wheel is mounted is connected to a non-rotary element 30 fixed to the vehicle body via rolling elements 40, so that the wheel mounted on the rotary element 20 is rotatably supported relative to the vehicle body. Further, a sealing member 50 is mounted in an end portion (or both end portions) of the vehicular wheel bearing 10 to prevent external foreign matters from entering inward of the bearing or prevent lubricant oil (grease) inside the bearing from leaking out of the bearing.

Referring to FIG. 2, there is exemplarily illustrated a sealing member 50 of a pack seal structure which may be used in a bearing device such as the vehicular wheel bearing 10 (an inboard-side sealing member illustrated in a portion A of FIG. 1).

The sealing member 50 illustrated in FIG. 2 comprises an outer part 60 positioned outward in a radial direction and an inner part 70 positioned inward in the radial direction. At least one of the outer part 60 and the inner part 70 comprises an elastic sealing portion 62. One or more sealing lips 64 provided in the elastic sealing portion 62 are arranged to be brought into contact with or adjacent to a counterpart member to perform a sealing function.

Incidentally, when the sealing member 50 is assembled with the bearing device (for example, the vehicular wheel bearing 10 illustrated in the drawings) and/or when the bearing device (for example, the vehicular wheel bearing 10 illustrated in the drawings) is operated, an internal pressure of an internal space of the bearing may be increased. This may cause leakage of lubricant oil (grease) in the internal space of the bearing or a degradation in sealing property.

### SUMMARY

### Technical Goals

The present invention was made for the purpose of solving the above matters, and the present invention is for the purpose of providing a sealing member configured to prevent high internal pressure (negative pressure) from being generated in a bearing space by an internal pressure discharging structure formed in the sealing member, and a bearing device including the same (for example, a vehicular wheel bearing).

### Technical Solutions

Representative configurations of the present invention to achieve the above objections are as follows.

According to an example embodiment of the present invention, there is provided a sealing member of a bearing device configured to rotatably support a rotary element relative to a non-rotary element in a rotating device via rolling elements. The sealing member according to an example embodiment of the present invention may comprise a frame mounted on one of the rotary element and the non-rotary element, and an elastic sealing portion attached to the frame. According to an example embodiment of the present invention, the frame may comprise a press-fitting portion extending in an axial direction and a flange portion extending in a radial direction from the press-fitting portion. According to an example embodiment of the present invention, the flange portion of the frame may have a through-hole, the elastic sealing portion may be configured to close the through-hole. According to an example embodiment of the present invention, at least one perforated-hole may be formed in the elastic sealing portion configured to close the through-hole, and a bearing space, in which the rolling elements are located, may be in communication with an outside via the at least one perforated-hole.

According to an example embodiment of the present invention, the elastic sealing portion may be inserted into the through-hole to form a filling portion.

According to an example embodiment of the present invention, the at least one perforated-hole may be formed in the filling portion.

According to an example embodiment of the present invention, the at least one perforated-hole may comprise a plurality of perforated holes.

According to an example embodiment of the present invention, the plurality of perforated-holes may be formed to extend in different directions.

According to an example embodiment of the present invention, the at least one perforated-hole may be formed to have a diameter of 1 millimeter (mm) or less.

According to an example embodiment of the present invention, the sealing member may further comprise a needle member inserted into the at least one perforated-hole. The needle member may be formed in a tubular structure having a perforated central portion.

According to an example embodiment of the present invention, the needle member may comprise a bent portion, which is bent in the radial direction, at one end portion thereof.

According to an example embodiment of the present invention, the bent portion may be formed to extend in a direction perpendicular to the axial direction.

According to an example embodiment of the present invention, the other end portion of the needle member may be configured such that an end thereof is spaced apart from the elastic sealing portion in the axial direction.

According to an example embodiment of the present invention, the other end portion of the needle member may be configured such that the end thereof is spaced apart at an interval of 3 mm or less from the elastic sealing portion in the axial direction.

According to an example embodiment of the present invention, the sealing member may further comprise a slinger mounted to the other of the rotary element and the non-rotary element.

According to an example embodiment of the present invention, a bearing device comprising the aforementioned sealing member may be provided.

According to an example embodiment of the present invention, the bearing device may be a vehicular wheel bearing configured to rotatably support a vehicular wheel relative to a vehicle body.

According to an example embodiment of the present invention, the sealing member may be a sealing member provided on an inboard-side of the vehicular wheel bearing.

In addition, a sealing member and a bearing device including the same (for example, a vehicular wheel bearing) according to the present invention may further comprise other additional configurations without departing from the technical sprit of the present invention.

### Technical Effects

A sealing member of a bearing device according to an example embodiment of the present invention is configured such that a through-hole is formed in a frame and at least one perforated-hole is formed in an elastic sealing portion for closing the through-hole. With this configuration, a bearing space may be in communication with the outside via the at least one second perforated-hole, which makes it possible to discharge an internal pressure of the bearing space to the outside, and prevent grease from leaking or prevent sealing property from being degraded due to high internal pressure generated in the bearing space.

### BRIEF DESCRIPTION OF THE DRAWINGS

FIG. 1 exemplarily illustrates, as an example of a bearing device, a vehicular wheel bearing which rotatably mounts and supports a vehicular wheel to a vehicle body.

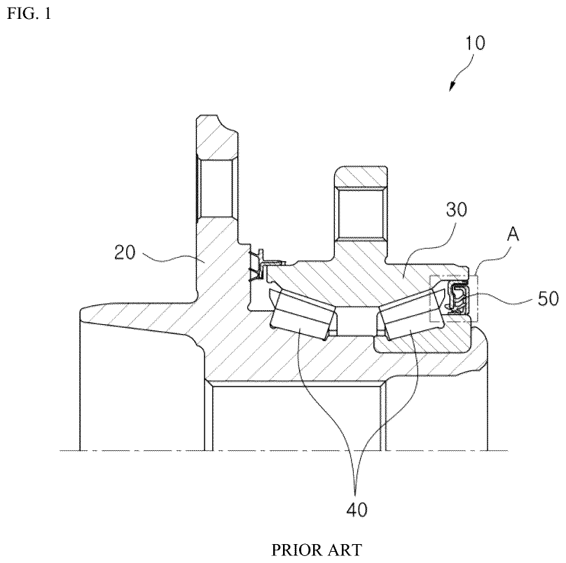

FIG. 2 exemplarily illustrates an example of a sealing member (for example, an inboard-side sealing member of a pack seal structure) which may be used in the vehicular wheel bearing in FIG. 1.

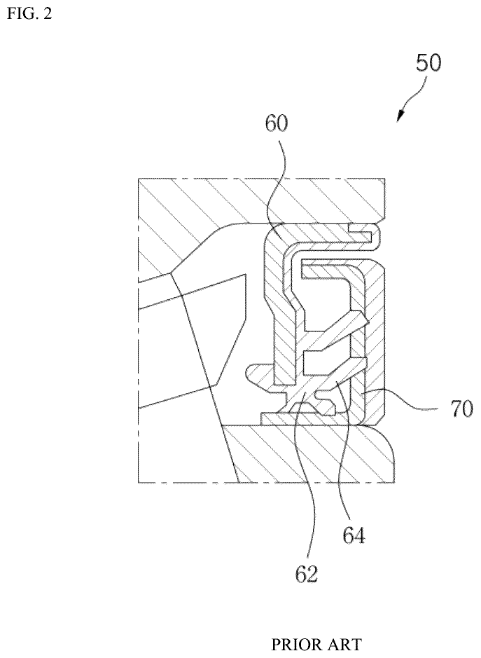

FIG. 3 exemplarily illustrates a structure of a bearing device (for example, a vehicular wheel bearing) according to an example embodiment of the present invention.

FIG. 4 exemplarily illustrates a sealing member (an inboard-side sealing member) of the vehicular wheel bearing illustrated in FIG. 3.

FIG. 5 exemplarily illustrates a frame of the sealing member illustrated in FIGS. 3 and 4 and an elastic sealing portion attached to the frame.

FIG. 6 exemplarily illustrates a modification of the sealing member illustrated in FIG. 5.

FIG. 7 exemplarily illustrates another modification of the sealing member illustrated in FIG. 5.

### DETAILED DESCRIPTION

Example embodiments of the present invention are exemplified in below for the purpose of describing the technical spirit of the present invention. However, the scope of the claims according to the present invention is not limited to the example embodiments described below or to the detailed descriptions of these example embodiments.

Unless otherwise defined, all technical and scientific terms used herein have the same meaning commonly understood by those skilled in the art to which the present invention pertains. All terms used herein are selected for the purpose of more clearly describing the present invention and not limiting the scope of the present invention defined by appended claims.

Unless the phrase or sentence clearly indicates otherwise, terms “comprising,” “including,” “having,” and the like used herein should be construed as open-ended terms encompassing the possibility of including other example embodiments.

The term “axial direction” used herein may be defined as a direction extending along a rotational central axis of a wheel bearing, the term “radial direction” used herein may be defined as a direction perpendicular to the axial direction and away from the rotational central axis or approaching the rotational central axis. The term “circumferential direction” used herein may be defined as a direction rotating about the axial direction described above.

Unless the phrase or sentence clearly indicates otherwise, the expression “a constituent element extends in the axial direction or the radial direction” used herein should be understood as encompassing a case where the constituent element extends parallel to the axial direction or the radial direction as well as a case where the constituent element extends obliquely with respect to the axial direction or the radial direction.

The singular form described herein may include the plural form unless the context clearly dictates otherwise, and this may be equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, example embodiments of the present invention will be described in detail with reference to the accompanying drawings at such an extent that they may be readily practiced by those ordinary skilled in the art. In the accompanying drawings, the same reference numerals are assigned to the same or corresponding components. Further, in the following descriptions of the example embodiments, duplicate descriptions of the same or corresponding constituent elements may be omitted. However, even though a description(s) of a constituent element is omitted, such a constituent element is not intended to be excluded in any example embodiment.

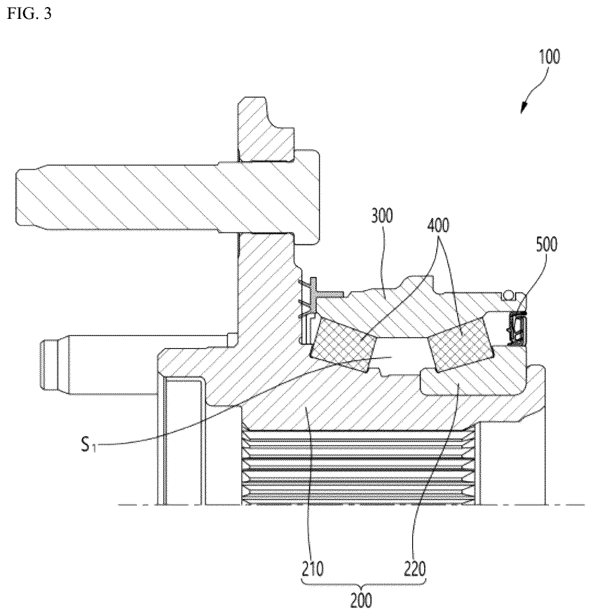

Referring to FIGS. 3 to 7, there are exemplarily illustrating a sealing member and a bearing device including the same (for example, a vehicular wheel bearing) according to example embodiments of the present invention.

Hereinafter, the sealing member and the bearing device including the same according to example embodiments of the present invention will be described using an example embodiment of the vehicular wheel bearing illustrated in the drawings, but the present invention is not limited thereto and may be modified into various other configurations.

According to an example embodiment of the present invention, a bearing device 100 (a vehicular wheel bearing) may be configured such that a rotary element 200 is rotatably connected with respect to a non-rotary element 300 via rolling elements 400, similar to a bearing device in the related art.

In a case of an example embodiment illustrated in the drawings, the bearing device 100 is configured such that a radially inner member serves as the rotary element 200 and a radially outer member serves as the non-rotary element 300. Alternatively, the bearing device 100 according to an example embodiment of the present invention may be modified into another configuration in which the radially outer member serving as the rotary element 200 and the radially inner member serving as the non-rotary element 300.

As illustrated in the drawings, in the case where the bearing device 100 according to an example embodiment of the present invention is configured as the vehicular wheel bearing, the rotary element 200 may comprise a wheel hub 210 on which a vehicular wheel is mounted and an inner ring 220 mounted on the wheel hub 210, and the non-rotary element 300 may comprise an outer ring or the like mounted on and fixed to a chassis member or the like of the vehicle.

According to an example embodiment of the present invention, the wheel hub 210 constituting the rotary element 200 may be formed in a substantially cylindrical shape extending along the axial direction, and a wheel mounting flange (hub flange) may be provided on an outer circumferential surface of the wheel hub 210. The wheel mounting flange may be formed in a shape extending outward in the radial direction from the outer circumferential surface of the wheel hub 210 and may be used to mount the vehicular wheel on the wheel hub 210 with hub bolts or the like. Further, a raceway (inner raceway) may be formed on a portion of the outer circumferential surface of the wheel hub 210 to support the rolling elements 400 from an inner side in the radial direction.

According to an example embodiment of the present invention, one or more inner rings 220 may be mounted on the outer circumferential surface of the wheel hub 210. A raceway (inner raceway) for the rolling elements may be formed on an outer circumferential surface of the inner ring 220 to support the rolling elements 400 from an inner side in the radial direction. For example, the inner ring 220 may be mounted on a seating portion provided at a vehicle-body-side end portion of the wheel hub 210 in a press-fitting manner, and may be fixed to the wheel hub 210 while being applied with a predetermined preload.

According to an example embodiment of the present invention, the outer ring constituting the non-rotary element 300 may have an outer circumferential surface on which a vehicle-body-side mounting flange is formed to mount the wheel bearing on the vehicle body, and an inner circumferential surface on which raceways (outer raceways) in contact with the rolling elements 400 are formed. The raceway (outer raceway) formed on the inner circumferential surface of the outer ring may cooperate with the raceway (inner raceway) formed on the wheel hub 210 and/or the inner ring 220 to accommodate and support the rolling elements 400, which are rolling members, between the raceways.

According to an example embodiment of the present invention, the rolling elements 400 may be arranged between the rotary element 200 and the non-rotary element 300 to rotatably support the rotary element 200 relative to the non-rotary element 300.

The above-described configurations of the bearing device 100 (the vehicular wheel bearing) according to an example embodiment of the present invention are not necessarily limited to those illustrated in the drawings, but may be modified into other various configurations.

For example, in the case of the example embodiment illustrated in the drawings, the bearing device 100 (the vehicular wheel bearing) is configured such that one raceway is formed directly on the outer circumferential surface of the wheel hub 210 to support the rolling elements 400. Alternatively, the bearing device 100 (the vehicular wheel bearing) according to an example embodiment of the present invention may be configured such that two inner rings 220 are mounted on the wheel hub 210 to support the rolling elements 400.

Further, in the case of the example embodiment illustrated in the drawings, the rolling elements 400 which rotatably supports the rotary element 200 relative to the non-rotary element 300 are configured in a tapered roller form. Alternatively, the rolling elements 400 may be formed as rolling members of other shapes, such as ball members having a spherical shape.

According to an example embodiment of the present invention, a sealing member 500 may be provided in an end portion of the bearing device 100 (the vehicular wheel bearing) to prevent external foreign matters from flowing into a bearing space S₁ in which the rolling elements 400 are arranged or prevent grease filled into the bearing space S₁ from leaking out of the bearing space S₁.

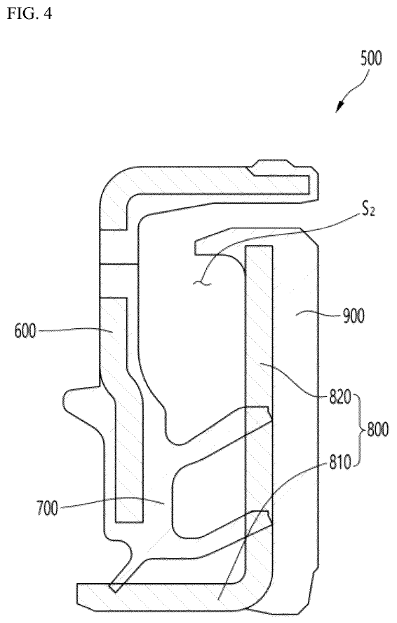

Referring to FIG. 4, a structure of the sealing member (an inboard-side sealing member in the case of the example embodiment illustrated in the drawings) that may be used in a bearing device 100 (the vehicular wheel bearing) according to an example embodiment of the present invention is exemplarily illustrated.

According to an example embodiment of the present invention, the sealing member 500 may comprise a frame 600 mounted on one of the rotary element 200 and the non-rotary element 300 of the bearing device 100.

According to an example embodiment of the present invention, the frame 600 may comprise a substantially cylindrical shaped press-fitting portion 610 extending in the axial direction and a flange portion 620 extending in the radial direction from the press-fitting portion 610.

According to an example embodiment of the present invention, an elastic sealing portion 700 may be integrally attached to the frame 600.

According to an example embodiment of the present invention, the elastic sealing portion 700 may be formed of an elastic material such as rubber, and may be formed to be integrally attached to the frame 600 by vulcanization or the like.

According to an example embodiment of the present invention, the elastic sealing portion 700 may be configured to surround a portion or all of the frame 600 from a radially inner end portion to a radially outer end portion of the frame 600.

According to an example embodiment of the present invention, the elastic sealing portion 700 may comprise one or more sealing lips 710. The sealing lips 710 may be arranged such that ends thereof are brought into contact with or adjacent to a counterpart member (for example, a slinger 800 illustrated in the drawings) so as to perform a sealing function.

According to an example embodiment of the present invention, the flange portion 620 of the frame 600 may have a through-hole(s) 630. The through-hole 630 may be closed by the elastic sealing portion 700.

According to an example embodiment of the present invention, the elastic sealing portion 700 may be inserted into the through-hole 630 formed in the flange portion 620 of the frame 600 to form a filling portion 720.

For example, when forming the elastic sealing portion 700 to the frame 600 by vulcanization, an elastic material constituting the elastic sealing portion 700 is flown into the through-hole 630, thereby forming the filling portion 720.

According to an example embodiment of the present invention, at least one perforated-hole 730 may be formed in a portion of the elastic sealing portion 700 (a portion of the filling portion 720 in a case that the filling portion 720 is formed in the through-hole 630 as illustrated in the drawings), which closes the through-hole 630, so that the bearing space S₁ may be in communication with the outside via the perforated-hole 730.

For example, in the case of the example embodiment illustrated in the drawings, the bearing space S₁ is in communication with an outer sealing space S₂ (a space formed in the sealing member 500) via the perforated-hole 730.

With this configuration, an internal pressure of the bearing space S₁ may be discharged to the outside via the perforated-hole 730, which makes it possible to suppress the internal pressure of the bearing space S₁ from being greatly increased and therefore prevent a negative pressure from being generated.

According to an example embodiment of the present invention, the perforated-hole 730 may preferably be formed to have a predetermined size so that external foreign matters are prevented from flowing into the bearing space S₁ via the perforated-hole 730 while easily discharging the internal pressure of the bearing space S₁ to the outside.

To do this, the perforated-hole 730 formed in the filling portion 720 of the elastic sealing portion 700 may preferably have a diameter of 1.0 millimeter (mm) or less.

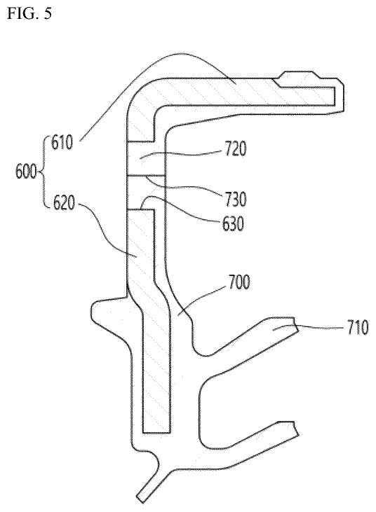

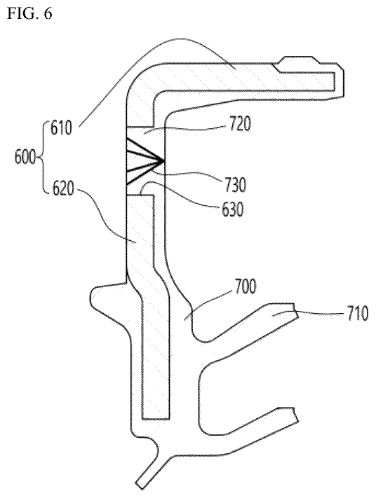

According to an example embodiment of the present invention, as illustrated in FIG. 5, one perforated-hole 730 may be formed in the elastic sealing portion 700. Alternatively, as illustrated in FIG. 6, a plurality of perforated-holes 730 may formed in the elastic sealing portion 700.

As illustrated in FIG. 6, in the case in which the plurality of perforated-holes 730 are formed in the elastic sealing portion 700, they may be formed to extend in different directions.

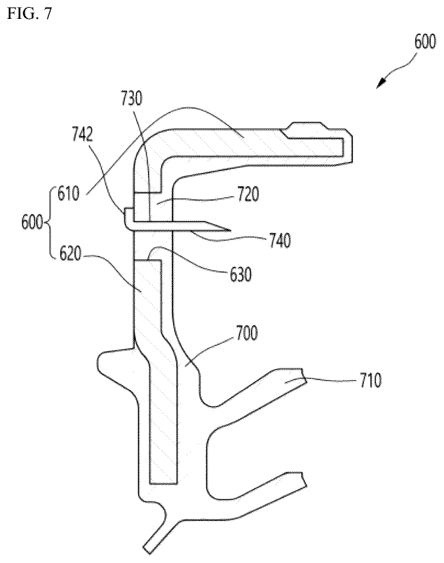

According to an example embodiment of the present invention, a needle member 740 may be inserted into the perforated-hole 730 formed in the elastic sealing portion 700 (see an example embodiment illustrated in FIG. 7).

According to an example embodiment of the present invention, the needle member 740 may be formed in a tubular structure having a perforated central portion. Even if the needle member 740 is inserted into the perforated-hole 730, the internal pressure of the bearing space S₁ may be discharged to the outside via the perforated central portion of the needle member 740.

According to an example embodiment of the present invention, the needle member 740, which is inserted into the perforated-hole730, may have a bent portion 742 bent in the radial direction at one end portion thereof (for example, an end portion located on the side of the bearing space S₁).

According to an example embodiment of the present invention, as illustrated in FIG. 7, the bent portion 742 may be formed in a flange shape extending in a direction perpendicular to the axial direction to prevent the needle member 740 inserted into the perforated-hole 730 from being separated from the perforated-hole 730.

According to an example embodiment of the present invention, the needle member 740, which is inserted into the perforated-hole730, may be configured such that an end of the other end portion thereof (for example, an end portion located on an opposite side of the bearing space S₁) is located to be spaced apart at a certain gap from the elastic sealing portion 700 in the axial direction.

According to an example embodiment of the present invention, the end of the other end portion of the needle member 740 may be positioned to be spaced apart by a distance of 3 mm or less from the elastic sealing portion 700 in the axial direction.

According to an example embodiment of the present invention, the sealing member 500 may further comprise the slinger 800 mounted to the other of the rotary element 200 and the non-rotary element 300 of the bearing device 100 (see FIG. 4).

According to an example embodiment of the present invention, the slinger 800 may comprise a substantially cylindrical shaped press-fitting portion 810 extending in the axial direction and a flange portion 820 extending in the radial direction from the press-fitting portion 810.

According to an example embodiment of the present invention, the slinger 800 may be positioned to face the frame 600 described above. The sealing lip(s) 710 of the elastic sealing portion 700 attached to the frame 600 may be positioned to be in contact with or adjacent to the slinger 800, thereby performing the sealing function.

According to an example embodiment of the present invention, an elastic member 900 (for example, an encoder for detecting a rotational speed or the like) may be additionally provided on one side of the slinger 800 as needed.

Although the present invention has been described above in terms of specific items such as detailed constituent elements as well as the limited example embodiments and the drawings, they are merely provided to help more general understanding of the present invention, and the present invention is not limited to the above example embodiments. Various modifications and changes could have been realized by those skilled in the art to which the present invention pertains from the above description.

Therefore, the spirit of the present invention need not to be limited to the above-described example embodiments, and in addition to the appended claims to be described below, and all ranges equivalent to or changed from these claims need to be the to belong to the scope and spirit of the present invention.

### EXPLANATION OF REFERENCE NUMERALS

100: Bearing device (for example, vehicular wheel bearing)
200: Rotary element
210: Wheel hub
220: Inner ring
300: Non-rotary element
400: Rolling element
500: Sealing member
600: Frame
610: Press-fitting portion (of frame)
620: Flange portion (of frame)
630: Through-hole (formed in flange portion of frame)
700: Elastic sealing portion (attached to frame)
710: Sealing lip
720: Filling portion
730: Perforated-hole
740: Needle member
742: Bent portion (of needle member)
800: Slinger
810: Press-fitting portion (of slinger)
820: Flange portion (of slinger)
900: Elastic member (for example, encoder) (attached to slinger)

What is claimed is:

1. A sealing member (500) of a bearing device (100) configured to rotatably support a rotary element (200) relative to a non-rotary element (300) in a rotating device via rolling elements (400), the sealing member comprising:
a frame (600) mounted on one of the rotary element (200) and the non-rotary element (300); and
an elastic sealing portion (700) attached to the frame (600),
wherein the frame (600) comprises a press-fitting portion (610) extending in an axial direction and a flange portion (620) extending in a radial direction from the press-fitting portion (610),
wherein a flange portion (620) of the frame (600) comprises a through-hole (630),
wherein the elastic sealing portion (700) is configured to close the through-hole (630), and
wherein at least one perforated-hole (730) is formed in the elastic sealing portion (700) configured to close the through-hole (630), and a bearing space S₁ in which the rolling elements (400) are located is in communication with an outside via the at least one perforated-hole (730).

2. The sealing member of claim 1, wherein the elastic sealing portion (700) is inserted into the through-hole (630) to form a filling portion (720).

3. The sealing member of claim 2, wherein the at least one perforated-hole (730) is formed in the filling portion (720).

4. The sealing member of claim 3, wherein the at least one perforated-hole (730) comprises a plurality of perforated-holes.

5. The sealing member of claim 4, wherein the plurality of perforated-holes (730) are formed to extend in different directions.

6. The sealing member of claim 3, wherein the at least one perforated-hole (730) is formed to have a diameter of 1 mm or less.

7. The sealing member of claim 3, further comprising: a needle member (740) inserted into the at least one perforated-hole (730),
wherein the needle member (740) is formed in a tubular structure has a perforated central portion.

8. The sealing member of claim 7, wherein the needle member (740) comprises a bent portion (742), which is bent in the radial direction, at one end portion thereof.

9. The sealing member of claim 8, wherein the bent portion (742) is formed to extend in a direction perpendicular to the axial direction.

10. The sealing member of claim 7, wherein the other end portion of the needle member (740) is configured such that an end thereof is spaced apart from the elastic sealing portion (700) in the axial direction.

11. The sealing member of claim 10, wherein the other end portion of the needle member (740) is configured such that the end thereof is spaced apart at an interval of 3 mm or less from the elastic sealing portion (700) in the axial direction.

12. The sealing member of claim 10, further comprising: a slinger (800) mounted on the other of the rotary element (200) and the non-rotary element (300).

13. A bearing device comprising the sealing member (500) of claim 1.

14. The bearing device of claim 13, wherein the bearing device is a vehicular wheel bearing configured to rotatably support a vehicular wheel relative to a vehicle body.

15. The bearing device of claim 14, wherein the sealing member (500) is a sealing member provided on an inboard-side of the vehicular wheel bearing.
